(19) United States
(12) Patent Application Publication
(10) Pub. No.: US 2025/0136379 A1
(43) Pub. Date: May 1, 2025

(54) RECEPTACLE CONFIGURED FOR CONVEYOR MOUNTING

(71) Applicant: Bedford Industries, Inc., Worthington, MN (US)

(72) Inventors: Trevor Wintz, Round Lake, MN (US); Derek Hanson, Brewster, MN (US); Axel Wass, Brewster, MN (US); David Schiller, Sioux Falls, SD (US)

(21) Appl. No.: 18/919,667

(22) Filed: Oct. 18, 2024

Related U.S. Application Data
(60) Provisional application No. 63/592,963, filed on Oct. 25, 2023.

(51) Int. Cl. B65G 17/36; B65C 3/00; B65C 9/02

(52) U.S. Cl. CPC B65G 17/36; B65C 3/00; B65C 9/02; B65G 2201/0211

(57) ABSTRACT

An apparatus is configured to be mounted on a conveyor that passes by a tagging machine, wherein the tagging machine is configured to apply a labeling article. The apparatus includes a first cup attached to the conveyor, a second cup slidably attached to the first cup, and a biasing mechanism that biases the second cup toward the conveyor. A method of applying a labeling article to a product comprises attaching a receptacle to a conveyor that passes by a tagging machine and positioning the product in the receptacle. An apparatus comprises a bar configured to be mounted on the conveyor and a receptacle including a base. The receptacle is configured to receive a product to which the labeling article is to be applied. The bar and base have a sliding interface for mutual connection and disconnection.

### CROSS REFERENCE TO RELATED APPLICATIONS

This application claims the benefit of priority from U.S. provisional patent application No. 63/592,963, filed Oct. 25, 2023; the content of the priority application is hereby incorporated by reference in its entirety.

### BACKGROUND

The banding of merchandise into groups of a size desired by consumers is well known and widely practiced. The band may consist of rubber, a twist-tie, or string and may be positioned about one or more bundles or clumps of merchandise or about a single item such as rolled or folded product (such as a newspaper, for example). A particularly popular and well-known practice is that of banding clumps of agricultural produce for easy handling in supply channels and attractive display to consumers. The marking of merchandise with information for inventory control and accuracy of processing by scanning (as at supermarket check-out counters), as well as for attractiveness of display for the consumer, has led to the development of unitary labeling and banding articles such as those described in commonly owned U.S. Pat. No. 7,281,345, entitled “Merchandise Labeling,” which is hereby incorporated by reference.

Such articles have a labeling tag bonded to an elastic loop, which is stretched to allow insertion of a portion of a merchandise product into the elastic loop. When the loop is released, it returns to its unstretched state to apply a compressive force that holds the article onto the merchandise product, thereby attaching the information label to the product. While such marking of merchandise can be accomplished manually, automation of the stretching and release of an elastic loop about a portion of a merchandise product has been performed, such as by using a tag applying machine produced by Northfield Corporation of De Pere, Wisconsin, under model name “ElastiTag® Neck Hanger Hang Tag Machine.” This automatic hangtag applicator machine is generally used to automatically place elastic labeling articles on products having a configuration such as a bottle or a canister that can be reliably conveyed past the elastic loop spreader arms of the machine on a linear conveyor.

### SUMMARY

In one aspect, an apparatus is configured to be mounted on a conveyor that passes by a tagging machine, wherein the tagging machine is configured to apply a labeling article. The apparatus comprises a first cup attached to the conveyor, a second cup slidably attached to the first cup, and a biasing mechanism that biases the second cup toward the conveyor.

In another aspect, a method of applying a labeling article to a product comprises attaching a receptacle to a conveyor that passes by a tagging machine, wherein the tagging machine is configured to apply the labeling article, and positioning the product in the receptacle.

In yet another aspect, an apparatus is configured to be mounted on a conveyor that passes by a tagging machine, wherein the tagging machine is configured to apply a labeling article. The apparatus comprises a bar configured to be mounted on the conveyor and a receptacle comprising a base. The receptacle is configured to receive a product to which the labeling article is to be applied. The bar and base have a sliding interface for mutual connection and disconnection.

This summary is provided to introduce concepts in simplified form that are further described below in the Detailed Description. This summary is not intended to identify key features or essential features of the disclosed or claimed subject matter and is not intended to describe each disclosed embodiment or every implementation of the disclosed or claimed subject matter. Specifically, features disclosed herein with respect to one embodiment may be equally applicable to another. Further, this summary is not intended to be used as an aid in determining the scope of the claimed subject matter. Many other novel advantages, features, and relationships will become apparent as this description proceeds. The figures and the description that follow more particularly exemplify illustrative embodiments.

### BRIEF DESCRIPTION OF THE DRAWINGS

The disclosed subject matter will be further explained with reference to the attached figures, wherein like structure or system elements are referred to by like reference numerals throughout the several views. All descriptions are applicable to like and analogous structures throughout the several embodiments, unless otherwise specified.

FIG. 1 is a perspective view of a system configured for automatically placing a labeling article onto a product, wherein the system features a first embodiment of a receptacle configured for mounting on a conveyor to receive the product.

FIG. 2 is a perspective view of the first embodiment of a receptacle.

FIG. 3 is a perspective view of the first exemplary receptacle holding an artichoke product and positioned on the conveyor downstream of the tag applicator machine.

FIG. 4 is a perspective view of a system including a plurality of second exemplary receptacles.

FIG. 5 is a perspective view of one of the second exemplary receptacles.

FIG. 6 is a cross-sectional view of the second exemplary receptacle, taken through line 6-6 of FIG. 5.

FIG. 7 is an exploded perspective view of the second exemplary receptacle.

FIG. 8A shows the second exemplary receptacle at the tag applicator machine, wherein the expanded loop is positioned onto an inner cup of the second exemplary receptacle.

FIG. 8B shows the second exemplary receptacle advancing up an inclined ramp, so that the outer cup moves upward relative to the inner cup, which has received a product, thereby pushing the elastomer loop upward.

FIG. 8C shows a subsequent step in which the elastomer loop is being pushed off the inner cup by the ascending outer cup as the second exemplary receptacle continues on an ascending side of the ramp.

FIG. 9 is a perspective view of the bundled and tagged product, which can be manually removed from the receptacle or conveyed to a receiving container such as a box placed under a downward turning portion of the conveyor track.

FIG. 10A is a perspective cross-sectional view of the second exemplary receptacle, taken along line 6-6 of FIG. 5, wherein a position of the receptacle relative to the ramp is similar to that depicted in FIG. 8B (product 74b and labeling article 78 are not shown).

FIG. 10B is a perspective cross-sectional view of the second exemplary receptacle, taken along line 6-6 of FIG. 5, wherein a position of the receptacle is at a peak of the ramp.

FIG. 10C is a perspective cross-sectional view of the second exemplary receptacle, taken along line 6-6 of FIG. 5, wherein a position of the receptacle is at a bottom of a descending side of the ramp.

FIG. 11 is a perspective view of a variation of the second exemplary receptacle with an adjustable height floor.

FIG. 12 is an exploded perspective view of the receptacle of FIG. 11.

FIG. 13A is a cross-sectional view of a receptacle, taken through line 13-13 of FIG. 11, in a first configuration.

FIG. 13B is a cross-sectional view of a receptacle, taken through line 13-13 of FIG. 11, in a second configuration.

FIG. 14 is a perspective view of a third exemplary receptacle.

FIG. 15 is a cross-sectional view of the third exemplary receptacle taken through line 15-15 of FIG. 14.

FIG. 16 is a side elevation view, viewed from the direction labeled “16” of FIG. 14.

FIG. 17 is an exploded perspective view of the third exemplary receptacle.

FIG. 18A is a perspective view of the third exemplary receptacle approaching horizontal ramps, wherein pegs configured to hold an elastomer loop of the labeling article are spaced apart from each other (labeling article 78 is not shown).

FIG. 18B shows a subsequent step in which the third exemplary receptacle rolls through a narrowed channel between the horizontal ramps, and the pegs are positioned close to each other to accept an elastomer loop of a labeling article (not shown).

FIG. 18C shows a subsequent step in which the third exemplary receptacle has passed the narrowed portion between the two horizontal ramps, and the pegs expand away from each other, similar to their position in FIG. 18A.

FIG. 18D shows a subsequent step in which the third exemplary receptacle begins its ascent up an inclined ramp.

FIG. 18E shows a subsequent step in which the third exemplary receptacle is at the top of the ramp, causing an expanded elastomer loop (not shown) on the pegs to be pushed off the pegs and onto a product (not shown) placed into the cup.

FIG. 18F shows a subsequent step in which the third exemplary receptacle descends the ramp, and the outer cup returns to its lowered position.

FIG. 19 is a perspective view of a fourth exemplary receptacle.

FIG. 20 is a front cross-sectional view of the fourth exemplary receptacle, taken at line 20-20 of FIG. 19.

FIG. 21 is a side elevation view of the fourth exemplary receptacle, taken from the direction labeled “21” in FIG. 19.

FIG. 22 is an exploded perspective view of the fourth exemplary receptacle.

FIG. 23A is a perspective view of the fourth exemplary receptacle after receipt of a labeling article on its fingers and insertion of a merchandise product.

FIG. 23B shows a subsequent step in which the fourth exemplary receptacle ascends a ramp, thereby pivoting brackets sideways to release the elastomer loop onto the merchandise product.

FIG. 23C is a perspective view showing the fourth exemplary receptacle at the top of the ramp; the labeling article and product are not shown so that structures of the receptacle are more clearly visible.

FIG. 24 is a perspective view of a variation of the fourth exemplary receptacle with an adjustable height floor.

FIG. 25 is an exploded perspective view of the receptacle of FIG. 24.

FIG. 26A is a perspective view of a first exemplary insert for a receptacle, configured to hold a product such as a coffee bag, for example.

FIG. 26B is a perspective view of a second exemplary insert, configured to hold a product such as one having a triangular shaped prism configuration.

FIG. 26C is a perspective view of a third exemplary insert, configured to hold a product shaped as a candy bar, for example.

FIG. 26D is a perspective view of a fourth exemplary insert configured to hold a product shaped as a flatter, wider chocolate bar, for example.

While the above-identified figures set forth one or more embodiments of the disclosed subject matter, other embodiments are also contemplated, as noted in the disclosure. In all cases, this disclosure presents the disclosed subject matter by way of representation and not limitation. It should be understood that numerous other modifications and embodiments can be devised by those skilled in the art that fall within the scope of the principles of this disclosure.

The figures may not be drawn to scale. In particular, some features may be enlarged relative to other features for clarity. Moreover, where terms such as above, below, over, under, top, bottom, side, right, left, vertical, horizontal, etc., are used, it is to be understood that they are used only for ease of understanding the description. It is contemplated that structures may be oriented otherwise.

The terminology used herein is for the purpose of describing embodiments, and the terminology is not intended to be limiting. Unless indicated otherwise, ordinal numbers (e.g., first, second, third, etc.) are used to distinguish or identify different elements or steps in a group of elements or steps and do not supply a serial or numerical limitation on the elements or steps of the embodiments thereof. For example, “first,” “second,” and “third” elements or steps need not necessarily appear in that order, and the embodiments thereof need not necessarily be limited to three elements or steps. Unless indicated otherwise, any labels such as “left,” “right,” “front,” “back,” “top,” “bottom,” “forward,” “reverse,” “clockwise,” “counter clockwise,” “up,” “down,” or other similar terms such as “upper,” “lower,” “aft,” “fore,” “vertical,” “horizontal,” “proximal,” “distal,” “intermediate” and the like are used for convenience and are not intended to imply, for example, any particular fixed location, orientation, or direction. Instead, such labels are used to reflect, for example, relative location, orientation, or directions. The singular forms of “a,” “an,” and “the” include plural references unless the context clearly dictates otherwise.

### DETAILED DESCRIPTION

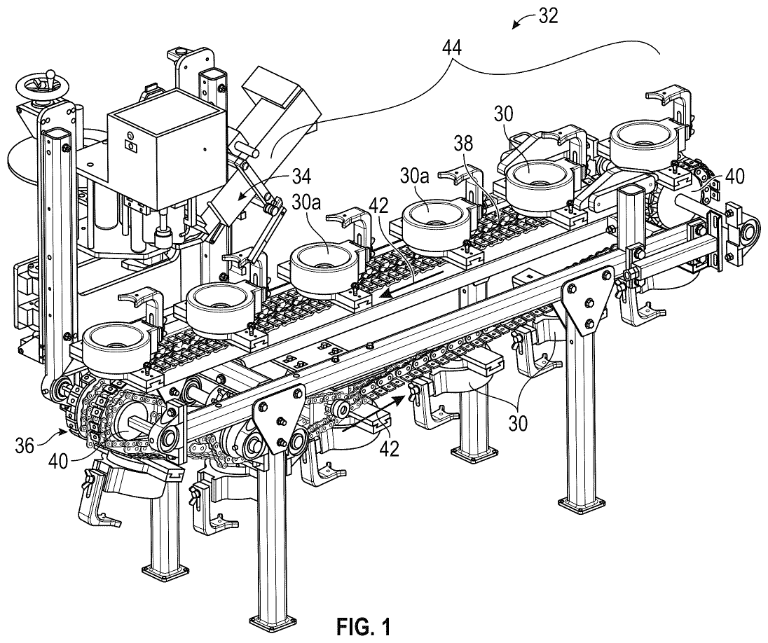

FIG. 1 is a perspective view of an automatic system for applying labeling articles onto products that are placed in a receptacle mounted on a conveyor. Such receptacles are useful for containing products that are not easily conveyed on their own. For example, while sturdy, upright items such as bottles or cans can be moved along a conveyor to a tag applicator machine without damage, other products benefit from being placed in a receptacle that orients the product in a desired position for receipt of a labeling article and/or contains a plurality of parts of a product (such as individual stalks of an asparagus bunch, for example). Four different embodiments of suitable receptacles are described herein, and they are provided with the same reference number but denoted with different letters. In some respects, the features and uses of the different embodiments of receptacles is similar. Thus, descriptions applying to one embodiment also apply to other embodiments unless otherwise stated.

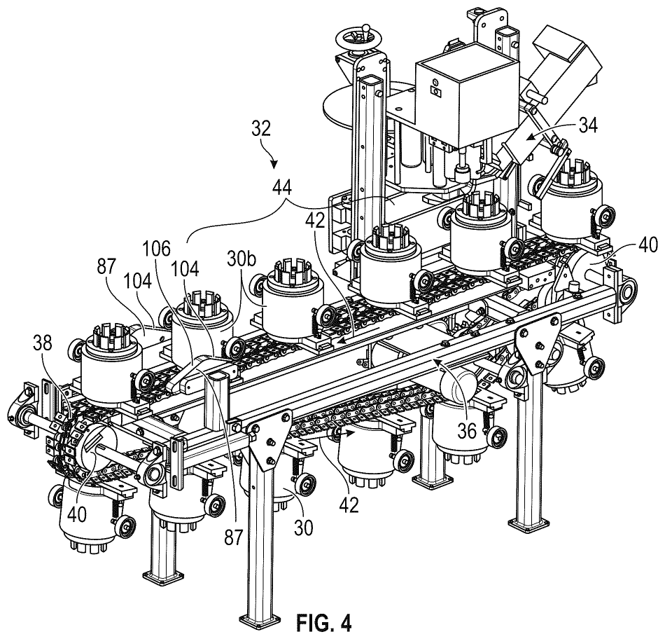

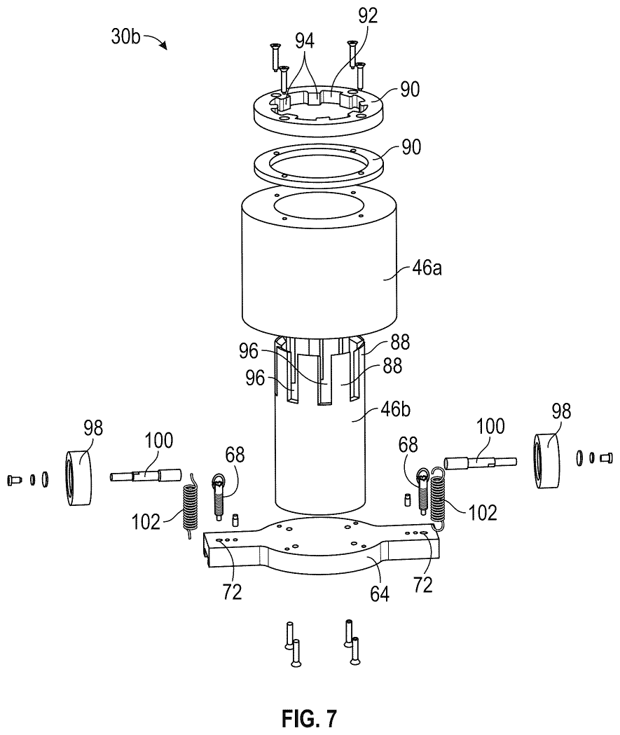

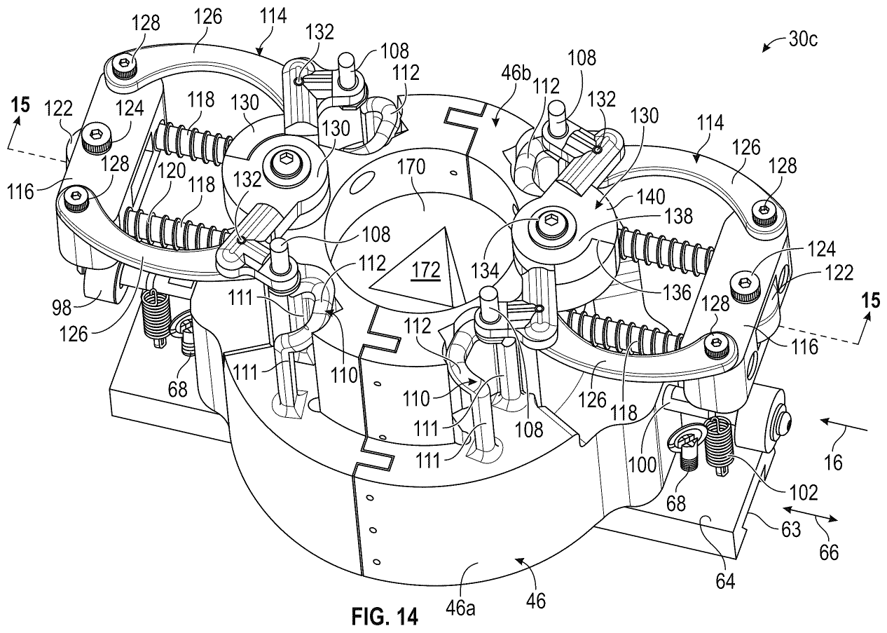

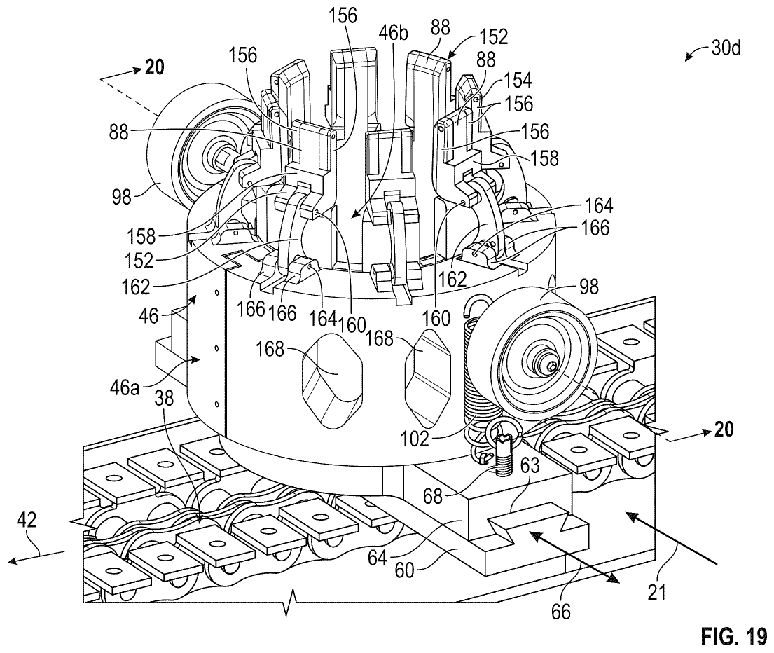

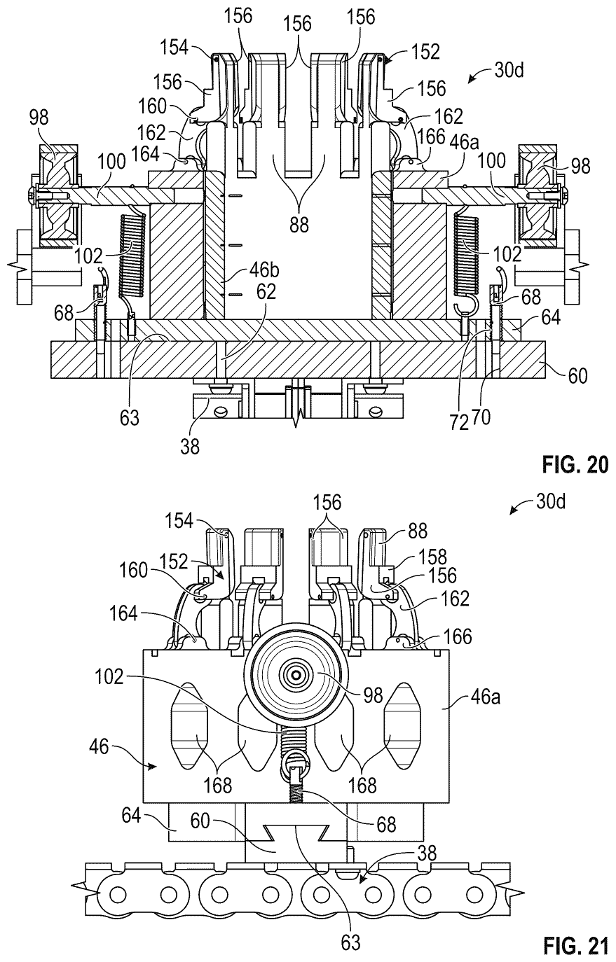

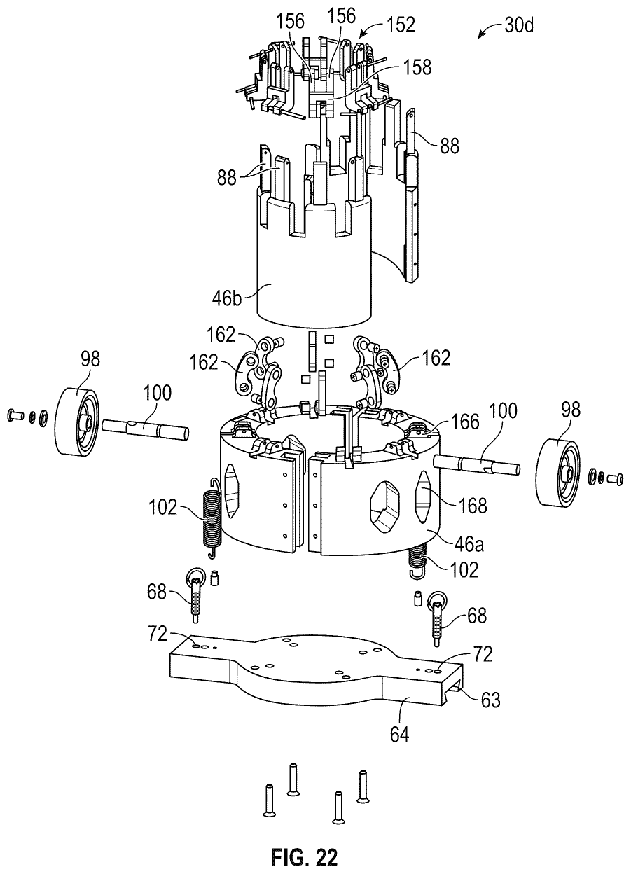

Four specific embodiments of a receptacle configured for mounting on a conveyor are described, and in some cases they will be differentiated by different lowercase letters after the reference number. However, in many aspects, the receptacles are similar; descriptions of receptacle 30, 30a, 30b, 30b′, 30c, 30d or 30d′ apply to all embodiments unless otherwise specified. This convention also applies to other similarly numbered elements. In this discussion, a receptacle in general is denoted with reference number 30. A first exemplary receptacle is shown in FIGS. 1-3 and is denoted as a static receptacle 30a. In FIGS. 4-13B, a second exemplary receptacle and a variation thereof are denoted as sliding receptacles 30b, 30b′. FIGS. 14-18F show a third exemplary receptacle, denoted as expanding receptacle 30c. FIGS. 19-25 show a fourth exemplary receptacle and a variation thereof, denoted as articulating receptacles 30d, 30d′.

FIG. 1 is a perspective view of an exemplary system 32, including tagging machine 34 and conveyor 36 having a plurality of receptacles 30 positioned at spaced distances along the conveyor 36, wherein the receptacles are configured as static receptacles 30a. Each of the receptacles 30 is fixed to an endless belt or conveyor chain 38 so that as the chain moves around the sprockets 40, even the upside-down facing receptacles 30 do not disengage from the chain 38. In this illustrated implementation, the belt movement direction 42 allows for a plurality of receptacles 30 to be positioned upright and in a product receiving orientation upstream of the tagging machine 34. Thus, even as the chain 38 with the receptacles 30 thereon moves at an efficient tagging feed speed, an operator has time to insert a product into each receptacle 30 in the work zone 44.

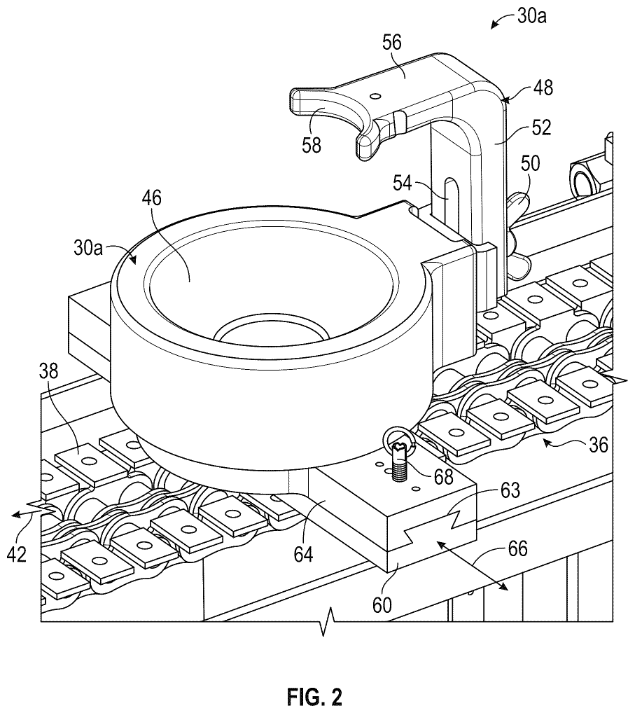

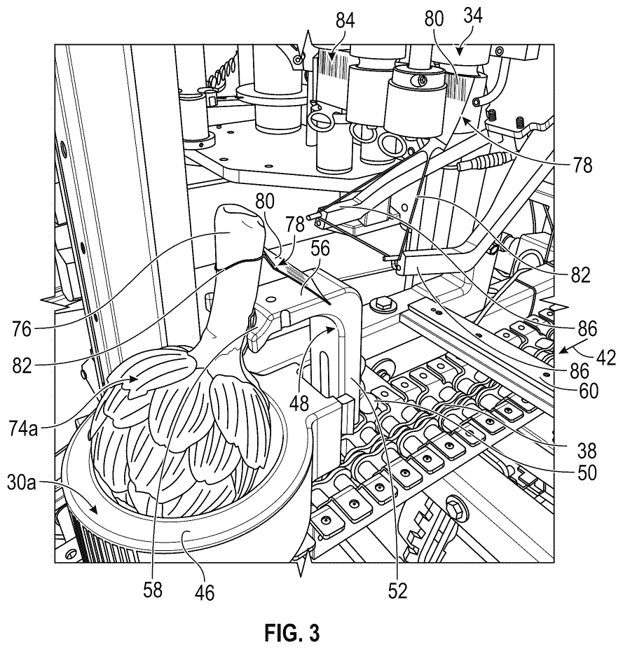

FIG. 2 is a perspective view of a single static receptacle 30a having a product receptacle cup 46 and an attached product support arm 48. In an exemplary embodiment, product support arm 48 is removably attachable to cup 46, such as by a readily operable fastener such as a wing nut 50, so that arms 48 of different configurations (such as height or support bracket shape) can be attached to the cup 46, depending on what merchandise product is to be deposited into cup 46. Referring to FIG. 3, this particular configuration of product support arm 48 is sized to support the stem of an artichoke product 74a. However, it is contemplated that arms of other configurations can be attached to cup 46 to facilitate the support and proper placement of a portion of a different product 74 for a receipt of a labeling article 78 thereon. In an exemplary embodiment, product support arm 48 has a generally vertical upright 52 with a vertical slot 54 through which the shaft of a wing nut 50 is inserted for some adjustability in the vertical position of the product support arm 48 relative to the cup 46. Moreover, in an exemplary embodiment a horizontally extending bracket 56 extends from the upright 52 and terminates in a product cradle 58, in association with cup 46.

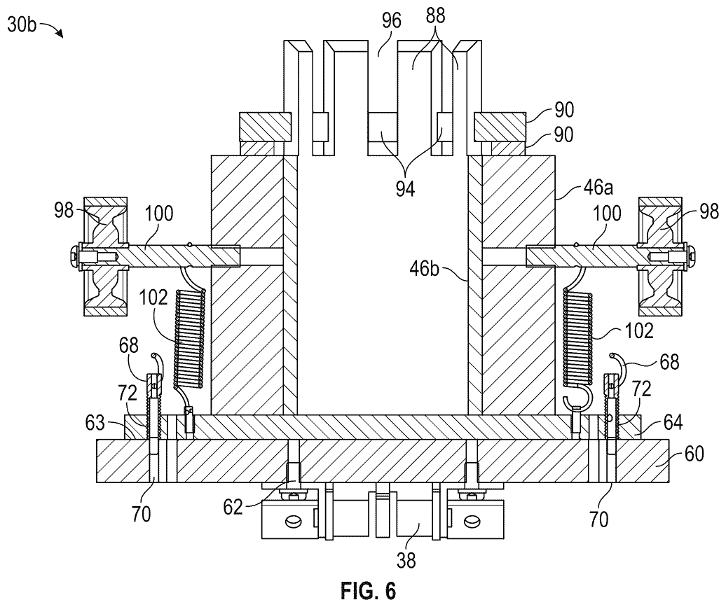

As shown in FIGS. 2 and 6, bar 60 is secured to conveyor chain 38 with fasteners 62. Base 64 of receptacle 30 has a mechanically cooperative structure with bar 60 to allow quick and simple attachment and detachment between the bar 60 and base 64. In the illustrated embodiment, the interlocking interface 63 resembles a dove tail joint, allowing the base 64 to slide on and off bar 60 in reciprocal linear directions 66. In an exemplary embodiment, spring pins 68 are used to quickly couple the bar 60 and base 64 when in the assembled illustrated position. In an exemplary embodiment, each spring pin 68 passes through aligned apertures 70 and 72 of bar 60 and base 64, respectively (see FIG. 6).

FIG. 3 shows receptacle 30a with a product 74 inserted in cup 46, wherein the product is an artichoke 74a. The artichoke 74a is placed into the cup 46 in the work zone 44 (see FIG. 1), with its stem 76 extending upright and supported by cradle 58 of product support arm 48. As illustrated in FIG. 3, the receptacle 30a has traveled in direction 42 past the tagging machine 34, which has installed a labeling article 78 onto stem 76 to thereby position tag 80 of the labeling article 78 onto product 74a. In an exemplary method of use, each labeling article 78 includes a tag 80 that is bonded to an elastomer loop 82. A plurality of such labeling articles 78 is provided in a rupturable strip 84 of articles, wherein at least the tag portions 80 of the articles are connected to each other, such as by perforations that can be torn apart between adjacent labeling articles 78. Additional details regarding labeling articles 78 are provided in U.S. Pat. No. 7,281,345, entitled “Merchandise Labeling,” and in U.S. Pat. No. 7,941,953, entitled “Separable Composite Labeling Articles in Sheet or Roll Form,” which are hereby incorporated by reference.

As shown in FIG. 3, loop spreader arms 86 of the tagging machine 34 have expanded the elastomer loop 82 of a labeling article 78 to be installed onto the product 74a held in the next receptacle 30a to pass by the tagging machine 34. The tagging machine 34 and conveyor 36 are set up relative to each other to position the labeling article 78 at an appropriate height relative to a product 74 traveling in direction 42. Moreover, the conveyor speed and the spacing between adjacent receptacles 30 is adjusted to allow one or more workers sufficient time in the work zone 44 for placing a product 74 into each cup 46 (see FIG. 1). As shown in FIG. 3, when appropriate, a receptacle 30 need not be attached to every bar 60 installed on conveyor chain 38. Moreover, the number of bars 60 and number of receptacles 30 can be varied depending on a length of the conveyor chain 38, the speed at which the chain is run, the type of product and care required for its deposition into the cup 46 without damage, and other factors.

FIG. 4 is a perspective view of an exemplary system 32, including tagging machine 34 and conveyor 36 having a plurality of receptacles 30 positioned at spaced distances along the conveyor 36, wherein the receptacles are configured as sliding receptacles 30b. Each of the receptacles 30b is fixed to the conveyor chain 38 so that as the chain moves around the sprockets 40, even the upside-down facing receptacles 30b do not disengage from the chain 38.

A difference in this system compared to that of FIG. 1 is that the tagging machine 34 is positioned at an upstream location relative to the upright receptacles 30 traveling in the chain direction 42 of the conveyor chain 38. This is because in this configuration of sliding receptacle 30b, the elastomer loop 82 of the labeling article 78 is applied directly to the sliding receptacle 30b rather than to a portion of the product 74 to be received within the sliding receptacle 30b.

In this illustrated implementation, the chain direction 42 allows for a plurality of receptacles 30b to be positioned upright and in a product receiving orientation downstream of the tagging machine 34. Thus, even as the belt with the receptacles 30b thereon moves at an efficient tagging feed speed, an operator has time to insert a product 74 into the receptacle 30b in the work zone 44 between tagging machine 34 and ramp 87.

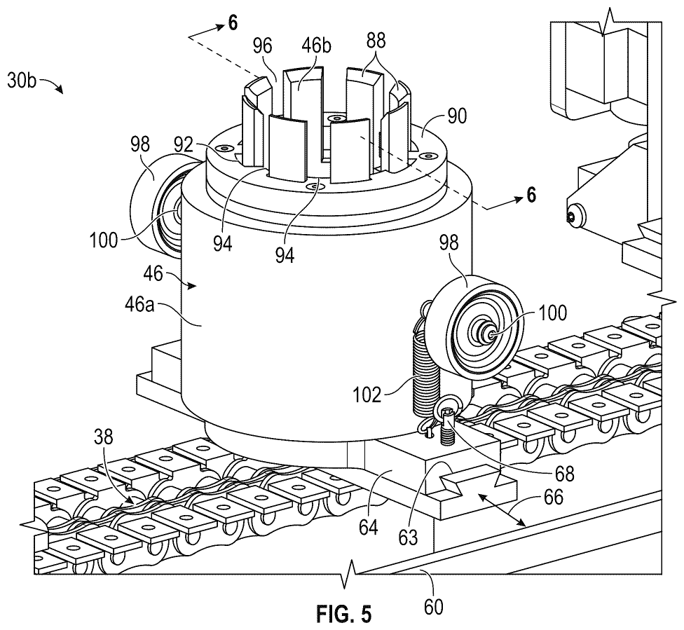

FIGS. 5-8C and 10A-13B show a single sliding receptacle 30b having an outer cup 46a and an inner cup 46b. In an exemplary embodiment, a top portion of the inner cup 46b is configured with a plurality of fingers 88. Cut out spaces or gaps 96 between adjacent fingers 88 reduce a surface contact area of the top portion of inner cup 46 with an elastomer loop 82 to be applied to the upper portion of the inner cup 46b. The gaps 96 facilitate disengagement of the elastomer loop 82 from the inner cup 46b, as will be explained below. In an exemplary embodiment, a top portion of outer cup 46a is provided with one or more rings 90. In an exemplary embodiment, at least one of the rings 90 includes a notched inner perimeter 92 that conforms to the configurations of fingers 88. Accordingly, the inwardly projecting teeth 94 of the notched inner perimeter 92 sit within the recesses or gaps 96 between adjacent fingers 88 to push upward on an elastomer loop 82 that spans around fingers 88 on an outer surface thereof.

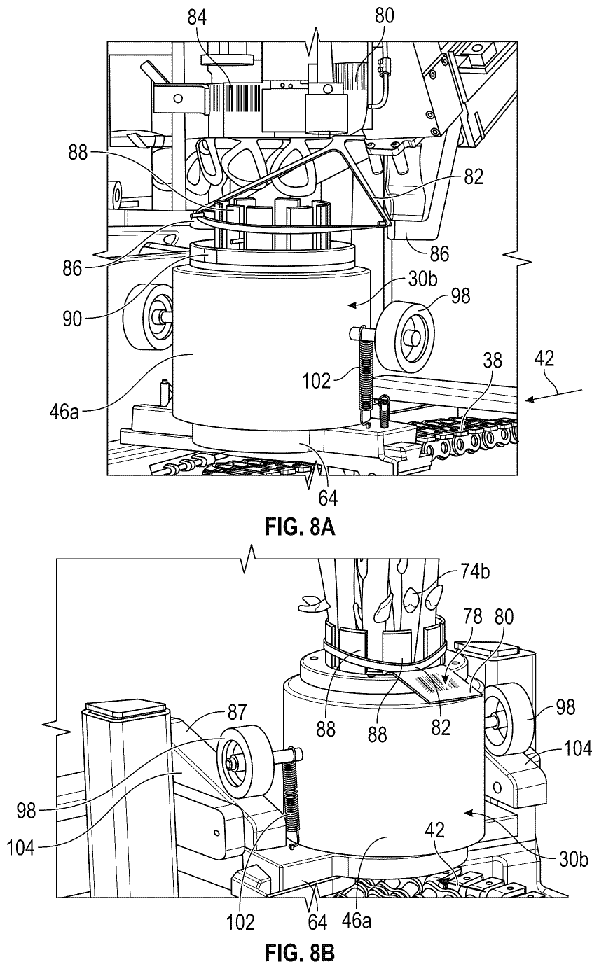

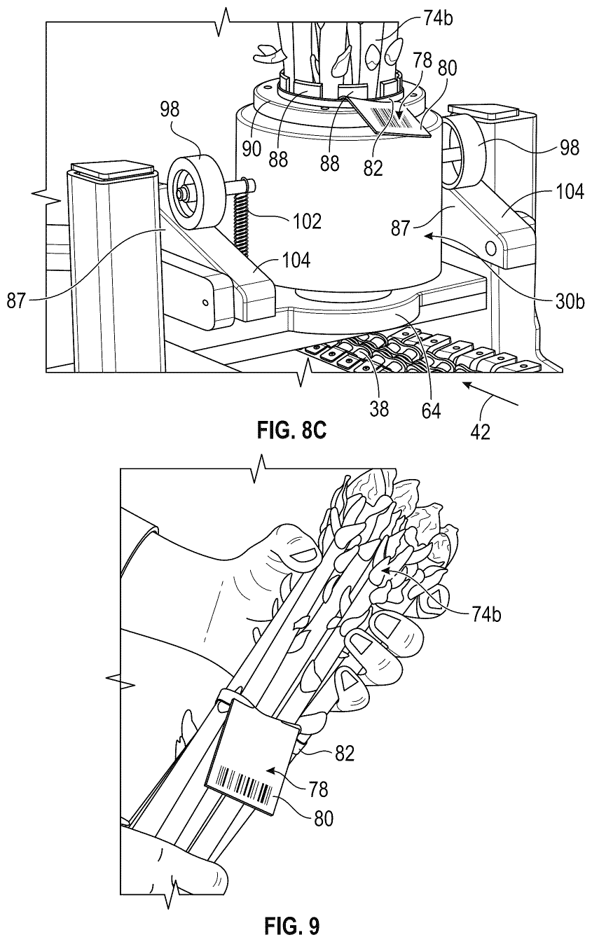

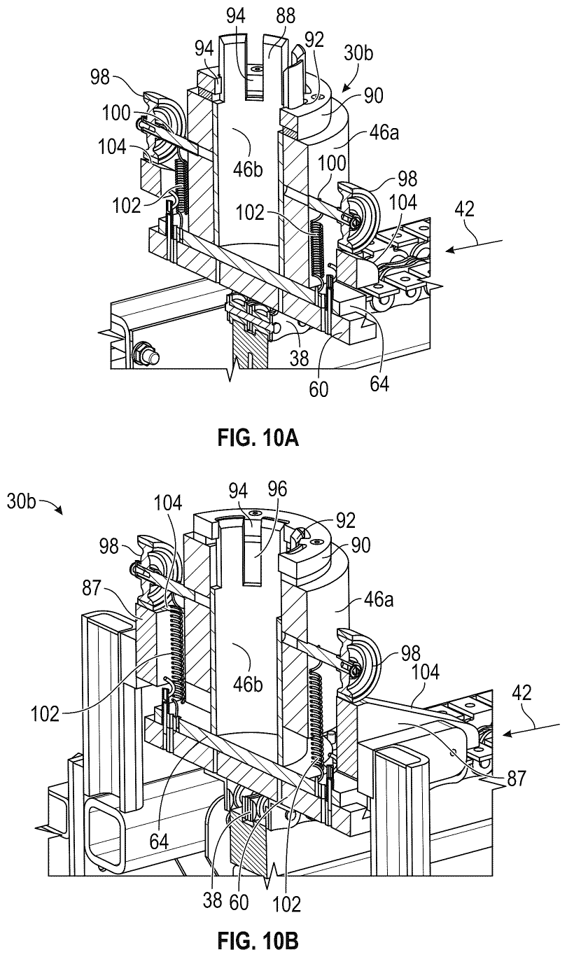

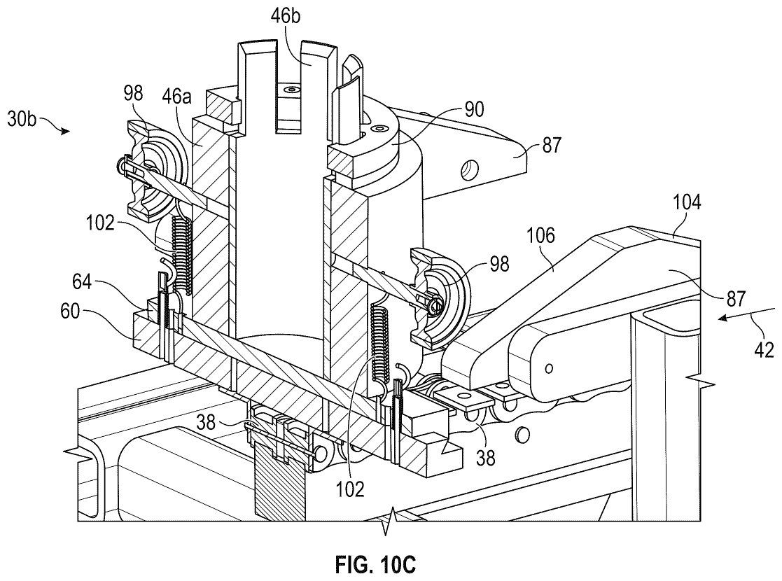

As shown in FIGS. 8A-10C, the outer cup 46a is configured to slide vertically up and down relative to the inner cup 46b. Rollers 98, via shafts 100, are affixed to outer cup 46a. A biasing mechanism 102, such as a helical tension spring, for example, is attached to and between each shaft 100 and base 64. As shown in FIGS. 8C and 10B, for example, as the outer cup 46a slides up vertically relative to the inner cup 46b, the biasing mechanism 102 stretches. The default bias of the mechanism 102 is toward a compressed state, thereby pulling the outer cup 46a down again relative to the inner cup 46b after descending the downwardly inclined ramp surface 106, as shown in FIG. 10C.

FIGS. 8A-8C and 10A-10C illustrate sets of sequential steps in the travel of receptacle 30b along conveyor 36 and relative to tagging machine 34. As shown in FIGS. 4 and 8A, receptacle 30b travels in direction 42 toward the loop spreader arms 86 of tagging machine 34. As shown in FIG. 8A, the loop spreader arms 86 are moved apart transversely to stretch open the elastomer loop 82 of a labeling article 78. The sliding receptacle 30b proceeds into the opened and expanded elastomer loop 82 so that a leading portion of the fingers 88 of the inner cup 46b catch on the expanded elastomer loop 82. As shown in FIGS. 4 and 8B, continued motion of the sliding receptacle 30b along the conveyance direction 42 pulls the labeling article 78 from the strip 84 of such articles, thereby rupturing this individual labeling article 78 from the strip 84. A user inserts a product 74 into the inner cup 46b while the sliding receptacle 30b is in the work zone 44, labeled in FIG. 4. In this illustration, the product is configured as asparagus stalks 74b. The labeling article 78 is held, in an expanded state, on the fingers 88 of the inner cup 46b.

FIGS. 10A-10C show some of the same positions of the sliding receptacle 30b as FIGS. 8B and 8C but are depicted in a cross-sectional view without product 74b. Thus, the relative motions of components of the sliding receptacle 30b are more visible. As shown in FIGS. 4, 8B and 10A, as sliding receptacle 30b is conveyed in direction 42 toward an end of the work zone 44, its rollers 98 ascend on upwardly inclined surfaces 104 of ramps 87. The inner cup 46b, which is fixed by base 64 to the conveyor chain 38, does not move upwardly. Thus, as shown in FIGS. 8C and 10B, as the sliding receptacle 30b progresses up the ramp surface 104, the outer cup 46a moves upward in a sliding vertical motion relative to the inner cup 46b. As the distance between roller shaft 100 and base 64 increases, the biasing mechanisms 102 stretch to accommodate the longer distance. As this happens, as shown in FIG. 8C, the teeth 94 of ring 90 at the top of outer cup 46a push upward on the portions of expanded elastomer loop 82 that span the gaps 96 between fingers 88. The elastomer loop 82 is thereby pushed off of the inner cup 46b and onto the product 74b held within the inner cup 46b; elastomer loop 82 contracts around and in engagement with product 74. As shown in FIG. 10C, further progression of the sliding receptacle 30b in conveyance direction 42 sends the rollers 98 on the downwardly inclined ramp surface 106, leaving the labeling article attached to the asparagus stalks 74b. As shown in FIG. 9, in this manner, the product is not only labeled, but the compressive elastomer loop 82 also performs a bundling function to hold together the individual stalks into a bundled product 74b that is convenient for handling and distribution.

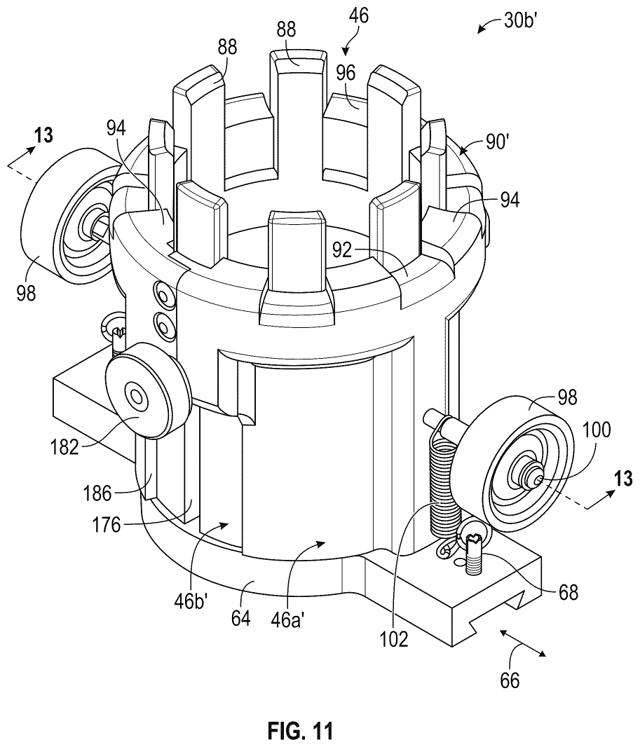

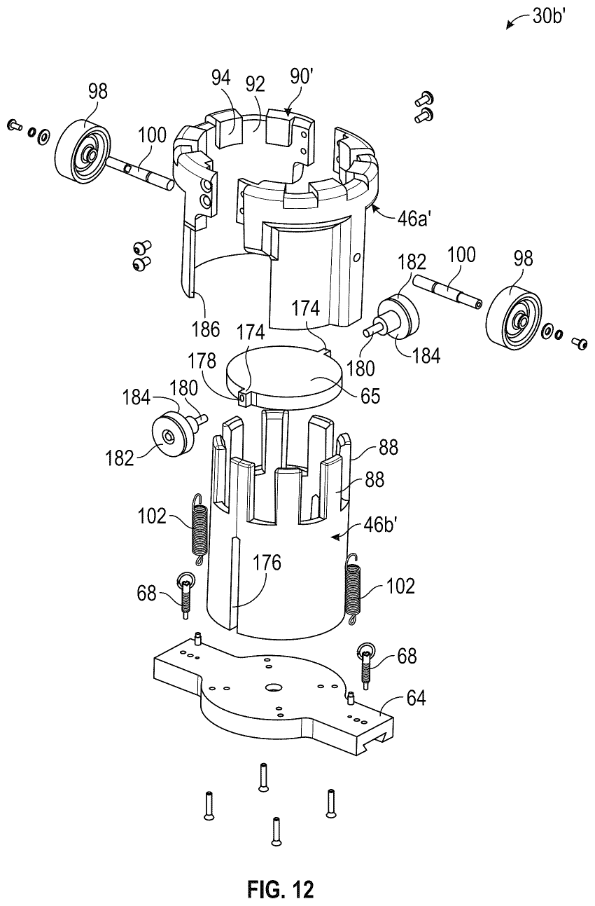

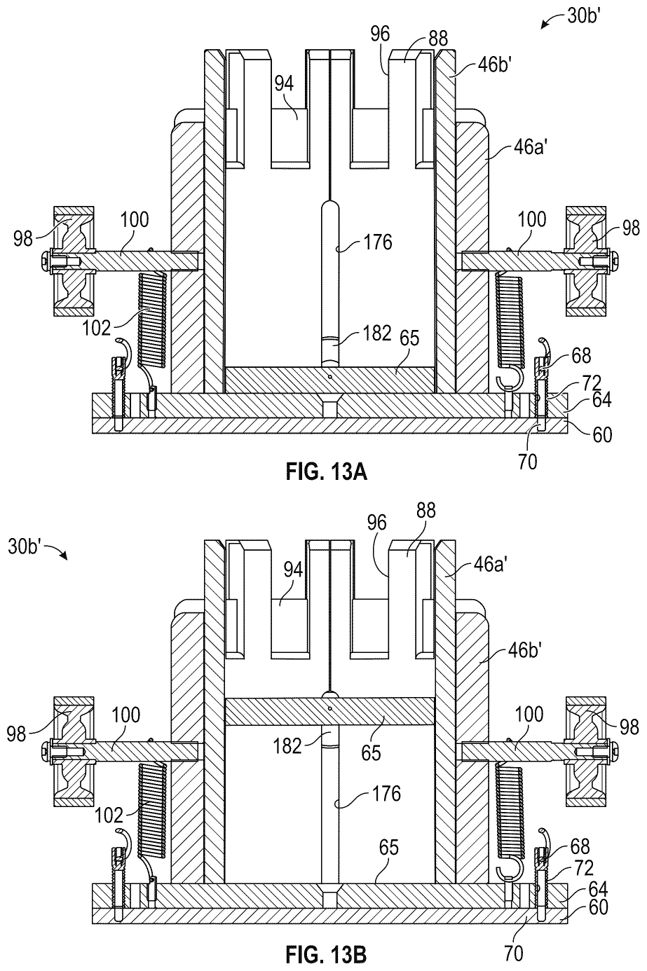

FIG. 11 is a perspective view of a variation of the second exemplary receptacle, designated as receptacle 30b′. FIG. 12 is an exploded perspective view of the receptacle of FIG. 11. FIG. 13A is a cross-sectional view of a receptacle, taken through line 13-13 of FIG. 11, in a first configuration. FIG. 13B is a cross-sectional view of a receptacle, taken through line 13-13 of FIG. 11, in a second configuration. This receptacle variation 30b′ is quite similar to receptacle 30b; primary differences are that it has an adjustable height floor 65 with changes in the structure of outer cup 46a′ and inner cup 46b′ to facilitate variability in a vertical position of the adjustable height floor 65. Sliding receptacle 30b′ has an outer cup 46a′ and an inner cup 46b′. In an exemplary embodiment, a top portion of the inner cup 46b′ is configured with a plurality of fingers 88. Cut out spaces or gaps 96 between adjacent fingers 88 reduce a surface contact area of the top portion of inner cup 46 with an elastomer loop 82 to be applied to the upper portion of the inner cup 46b. The gaps 96 facilitate disengagement of the elastomer loop 82 from the inner cup 46b.

In an exemplary method of assembly of receptacle 30b′, adjustable height floor 65 is inserted into an interior of the inner cup 46b′ from below, so that protrusions 174 are vertically slidable in slots 176 of inner cup 46b′. In an exemplary embodiment, each protrusion 174 has a threaded aperture 178 configured to receive a correspondingly externally threaded shaft 180 of knob 182. When assembled, knobs 182 can be tightened to compress holding surface 184 against an exterior of the inner cup 46b′ around the periphery of each slot 176, to thereby retain a desired height or elevation of adjustable floor 65 within the inner cup 46b′, as illustrated in FIGS. 13A and 13B.

In an exemplary embodiment, the outer cup 46a′ is provided in two parts, which when assembled maintain an opening 186 in which the knobs 182 on each side of the sliding receptacle 30b′ can move up and down along slots 176. In an exemplary embodiment, each of the two sections of outer cup 46a′ has an integral rim 90′ that has a notched inner perimeter 92 that conforms to the configurations of fingers 88. Accordingly, the inwardly projecting teeth 94 of the notched inner perimeter 92 sit within the recesses 96 between adjacent fingers 88 to push upward on an elastomer loop 82 that spans around fingers 88 on an outer surface thereof.

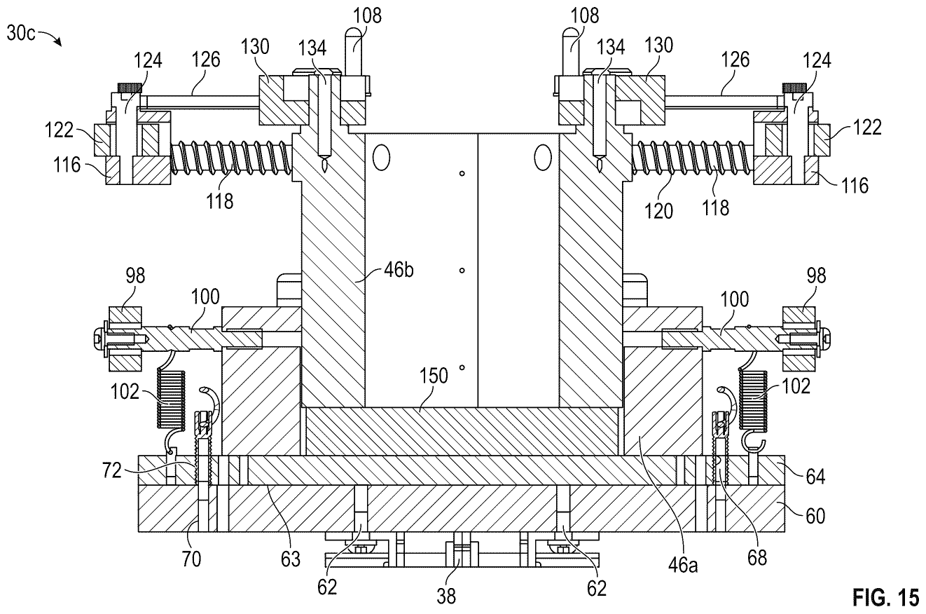

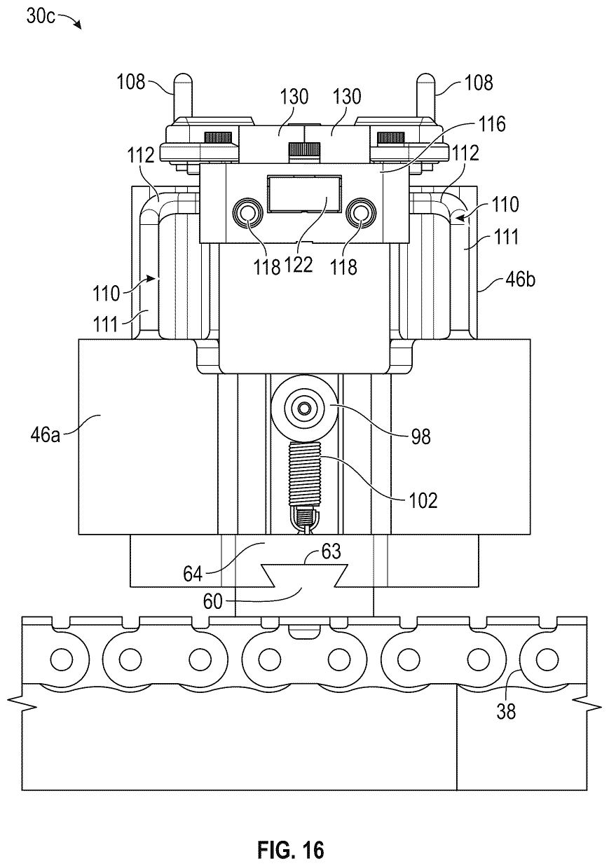

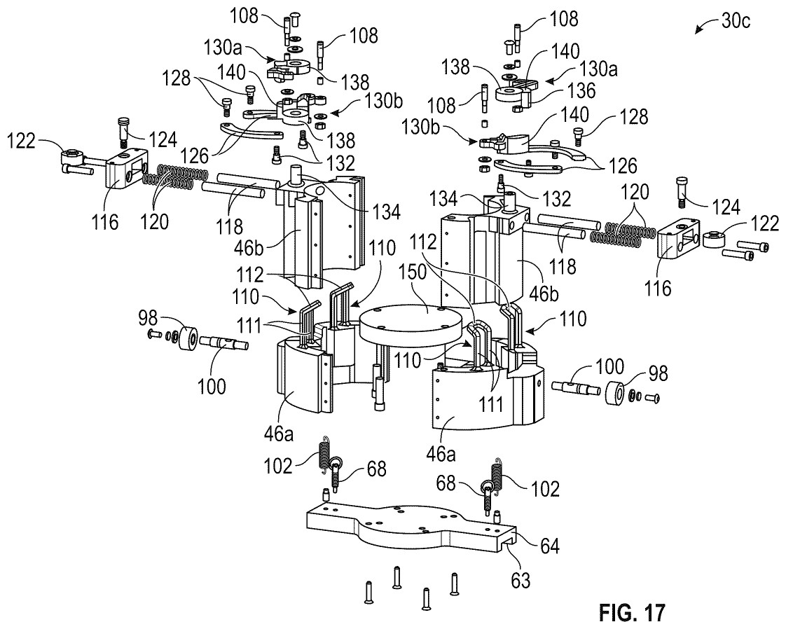

FIG. 14 shows a single expanding receptacle 30c having an outer cup 46a and an inner cup 46b. FIG. 15 is a cross-sectional view of the third exemplary receptacle 30c taken through line 15-15 of FIG. 14. FIG. 16 is a side elevation view, viewed from the direction labeled “16” of FIG. 14. FIG. 17 is an exploded perspective view of the third exemplary receptacle 30c. In an exemplary embodiment, two halves of inner cup 46b are assembled on a riser disc 150 on base 64. The two halves of outer cup 46a surround the riser 150 and a bottom portion of the inner cup 46b. Riser disc 150 can be provided with different height dimensions, so that a suitable disk for a particular product 74 can be selected.

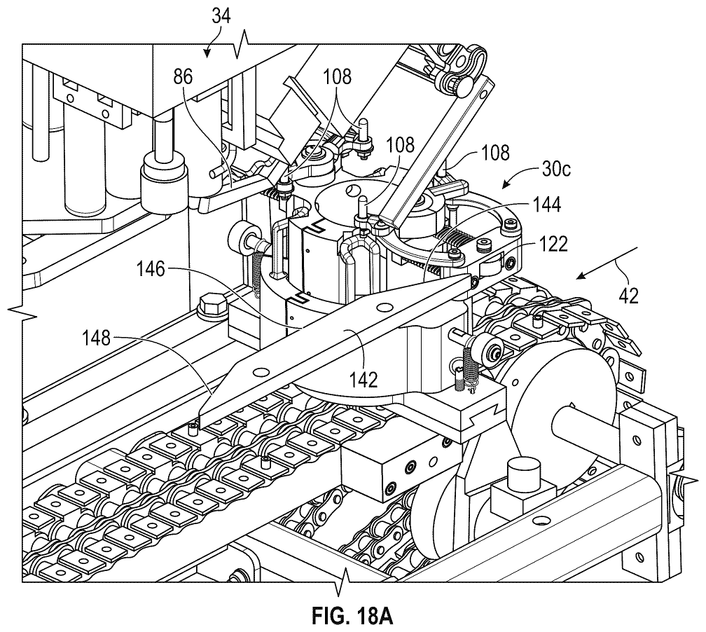

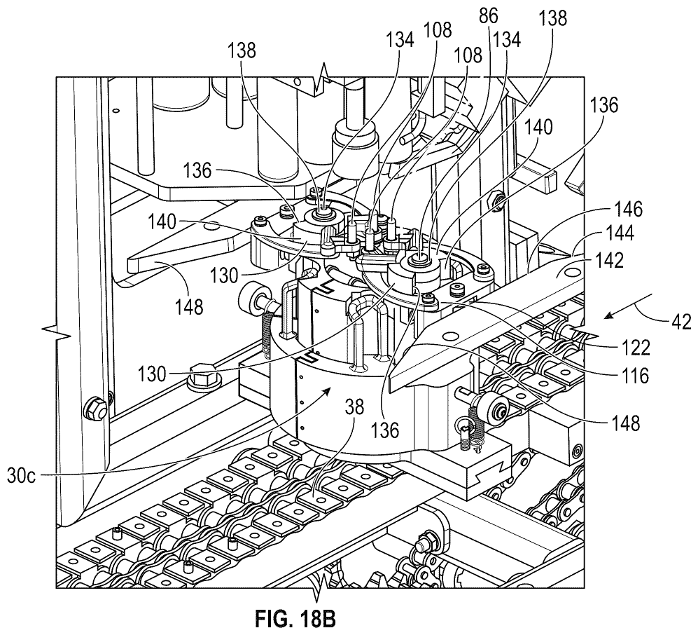

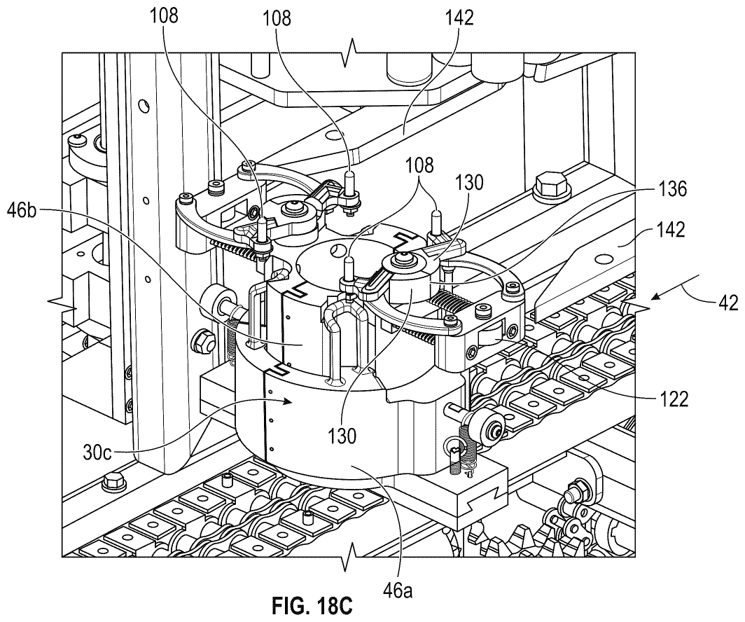

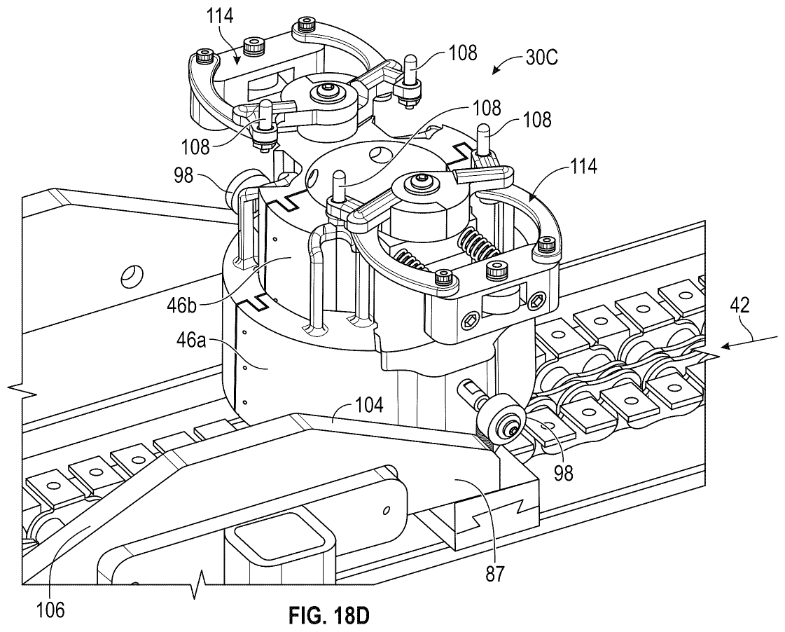

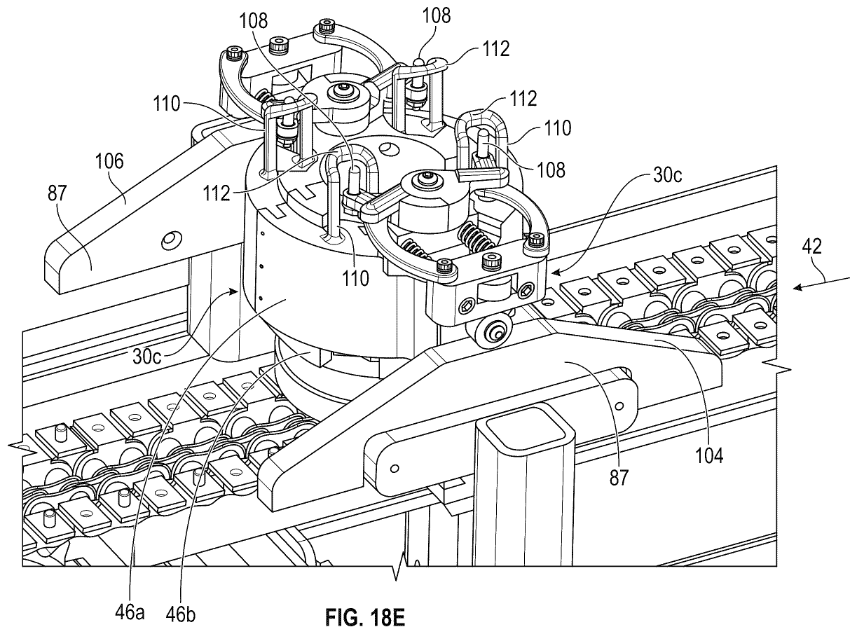

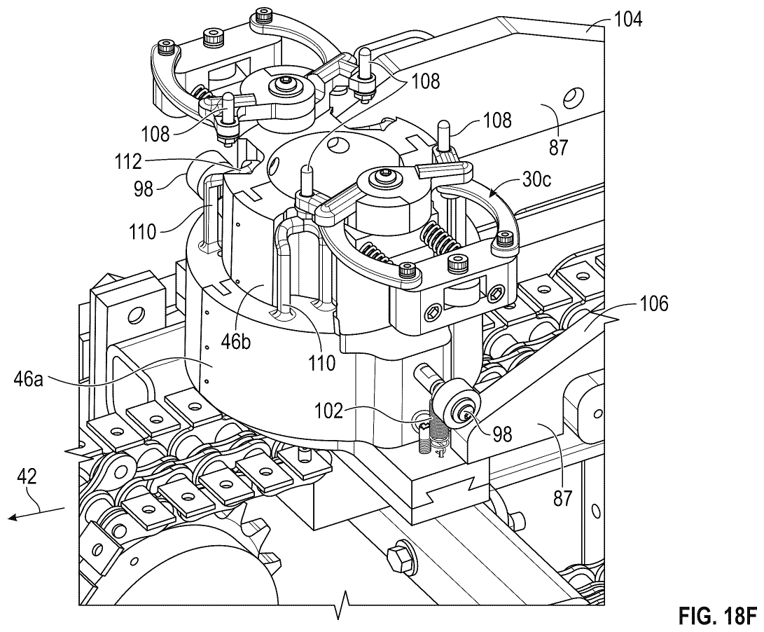

In an exemplary embodiment, a top portion of the inner cup 46b is configured with a plurality of fingers shaped as pegs 108 and configured to receive and stretch elastomer loop 82 of labeling article 78. In an exemplary embodiment, a top portion of outer cup 46a is provided with one or more stands 110, each stand 110 having two legs 11 connected by a top bridge 112 that is positioned radially inward of a respective peg 108. Accordingly, the inwardly extending bridges 112 of the outer cup 46a are positioned to push upward on an elastomer loop 82 that spans around pegs 108 on an outer surface thereof when outer cup 46a is raised relative to inner cup 46b, as shown in FIG. 18E.

In an exemplary embodiment, a pair of pegs 108 is disposed on a spring mount assembly 114 attached to each side of the inner cup 46b. As shown in FIGS. 14-17, roller bar 116 is connected to inner cup 46b by a pair of shafts 118 surrounded by compression springs 120. In an exemplary embodiment, roller 122 is held in bar 116 to rotate about axle 124. One end of each arm 126 is pivotally connected to roller bar 116 at pivot pin 128. Each linkage 130 is pivotally connected to an opposite end of arm 126 at pivot point 132 and is connected to inner cup 46b at pivot shaft 134. A peg 108 is disposed on an end of linkage 130 opposite the pivot shaft 134. In an exemplary embodiment, the two complementary linkages 130 of a single spring mount assembly 114 are configured with vertical stop surfaces 136 that meet and contact each other when the pegs 108 are in the expanded configuration of FIGS. 14 through 16, 18A and 18C-18F. However, when the pegs 108 are in the contracted configuration of FIG. 18B, these vertical surfaces 136 open apart as the respective linkages 130 pivot about pivot shaft 134. In an exemplary embodiment, each complementary linkage 130a, 130b has a radially inner, substantially circular portion 138 having a height that is about half of the height of pivot shaft 134. Thus, the two complementary linkages 130a, 130b stack upon each other at their circular portions 138. In contrast, an arcuate outer radial portion 140 of each linkage 130 has a height that is substantially equal to a height of the pivot shaft 134. Thus the vertical stop wall surfaces 136 of each of the arcuate portions 140 also extend a full height of the pivot shaft 134.

FIGS. 18A-18F illustrate sequential steps in the travel of receptacle 30c along conveyor 36 and relative to tagging machine 34. FIG. 18A shows receptacle 30c just upstream of a tagging area of machine 34. A portion of one loop spreader arm 86 is omitted so that structures of receptacle 30c are more visible. In FIGS. 18B and 18C, receptacle 30c is in positions to receive and carry labeling article 78; however, the labeling article 78 is not shown so that structures of receptacle 30c are more visible. In FIGS. 18D-18F, receptacle 30c is in positions to receive and carry labeling article 78 and product 74; however, the labeling article 78 and product 74 are not shown so that structures of receptacle 30c are more visible.

As shown in FIGS. 18A-18C, a pair of horizontal ramps 142 is positioned proximate the loop spreader arms 86 of tagging machine 34. Each of the horizontal ramps 142 includes converging surface 144, straight surface 146, and diverging surface 148. As shown in FIGS. 18A and 18B, as roller 122 rolls along converging surface 144 to straight surface 146, the springs 120 compress, allowing roller bar 116 to push the arms 126 laterally inward toward a center of receptacle 30c. Simultaneous pivoting of the linkages 130 about pivot shaft 134 and pivot pins 132 brings the attached pegs 108 closer to each other laterally and longitudinally. Thus, as shown in FIG. 18B when the receptacle 30c is rolled along the straight surfaces 146 of the horizontal ramps 142 toward the loop spreader arms 86 of tagging machine 34, the four pegs 108 of the receptacle 30c are placed close together to form a compact target for the stretched elastomer loop 82 held on loop spreader arms 86. Articulation of the tagging machine is not illustrated in these views, but it is to be understood that the loop spreader arms 86 are moved apart transversally to stretch open the elastomer loop 82 of a labeling article 78, such as shown in FIG. 3. While the pegs 108 are in the contracted configuration shown in FIG. 18B, the receptacle 30c proceeds into the opened and expanded elastomer loop 82 so that leading pegs 108 of the inner cup 46b catch on the expanded elastomer loop 82.

Continued motion of the receptacle 30c along the conveyance direction 42 pulls the labeling article 78 from the strip 84 of such articles, thereby rupturing an individual labeling article 78 from the strip 84. As shown in FIG. 18C, as the expanding receptacle 30c continues in chain direction 42 past the diverging surfaces 148 of the horizontal ramp 142, the compression springs 120 of spring shaft 118 push the roller bars 116 laterally outward again, thereby assuming the receptacle configuration also shown in FIG. 18A, where the pegs 108 are expanded away from each other, but now while carrying a stretched elastomer loop 82 of a labeling article 78 thereon (though not illustrated). A user inserts a product 74 into the inner cup 46b while the receptacle 30c is in the work zone 44. The labeling article 78 is held on the pegs 108 of the inner cup 46b by its elastomer loop 82.

As shown in FIG. 18D, as receptacle 30c is conveyed in direction 42 toward an end of the work zone 44, its rollers 98 ascend on upwardly inclined surfaces 104 of ramps 87. The inner cup 46b, which is fixed by base 64 to the conveyor chain 38, does not move upwardly. Thus, as shown in FIG. 18E, as the expanding receptacle 30c progresses up the ramp surface 104, the outer cup 46a moves upward in a sliding vertical motion relative to the inner cup 46b. As the distance between roller shaft 100 and base 64 increases, the biasing mechanisms 102 stretch to accommodate the longer distance. As this happens, as shown in FIG. 18E, the bridges 112 of stands 110 at the top of outer cup 46a push upward on the portions of elastomer loop 82 that span between pegs 108. The elastomer loop 82 is thereby pushed off of the inner cup 46b and onto the product 74 (not shown) held within the inner cup 46b. As shown in FIG. 18F, further progression of the receptacle 30c in conveyance direction 42 sends the rollers 98 on the downwardly inclined ramp surface 106, leaving the labeling article attached to the product 74. The default bias of the mechanism 102 is toward a compressed state, thereby pulling the outer cup 46a down again relative to the inner cup 46b.

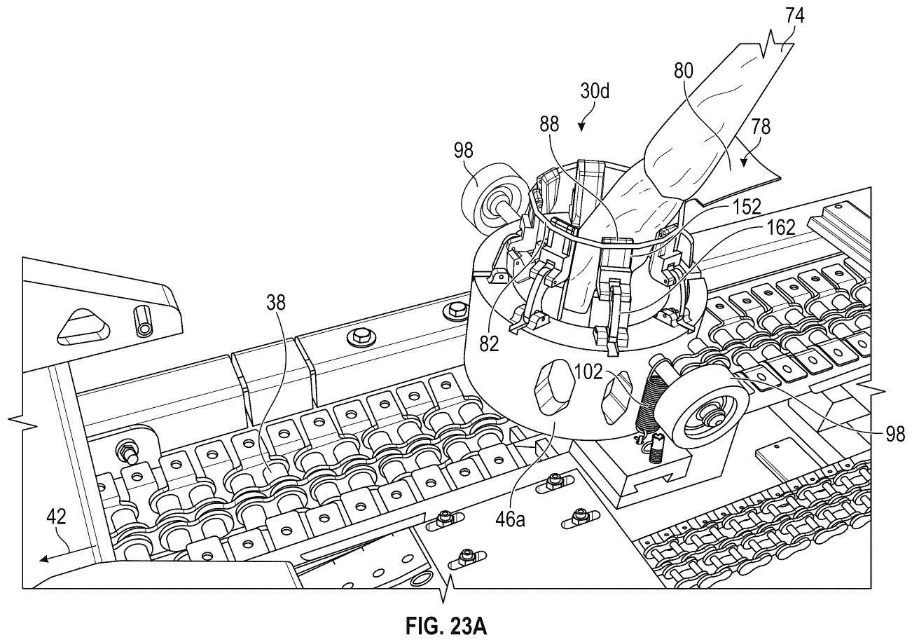

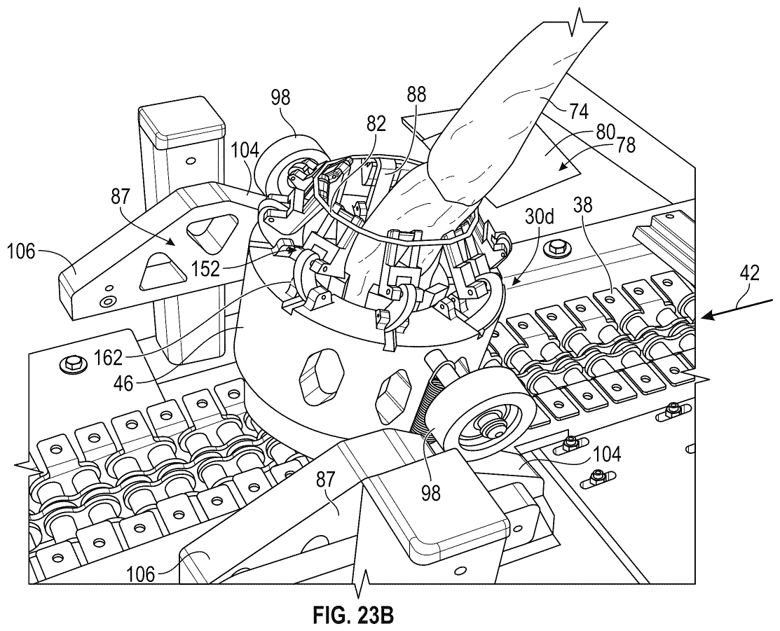

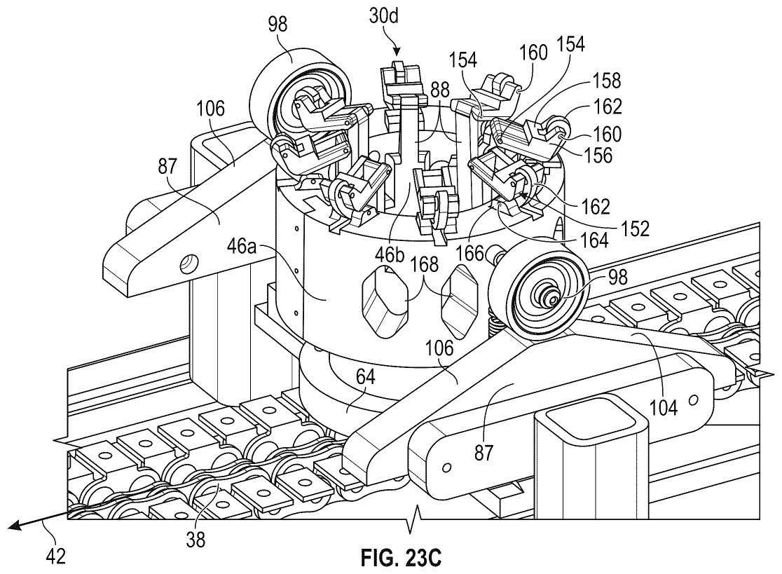

FIGS. 19-23C show a single articulating receptacle 30d having an outer cup 46a and an inner cup 46b. In an exemplary embodiment, two halves of inner cup 46b are assembled on base 64. The two halves of outer cup 46a surround a bottom portion of the inner cup 46b. In an exemplary embodiment, a top portion of the inner cup 46b is configured with a plurality of fingers 88. In an exemplary embodiment, a top portion of outer cup 46a is provided with a corresponding number of brackets 152, with each bracket 152 pivotally connected to its respective finger 88 at hinge 154. When nested together as shown in FIGS. 19-21 and 23A, the assembled fingers 88 and brackets 152 are configured to receive a stretched elastomer loop 82 (see FIGS. 23A and 23B) of labeling article 78.

In an exemplary embodiment, each bracket 152 has two substantially L-shaped side members 156 connected by a bridge 158. Hinge 160 at a lower extremity of each of the L-shaped side members 156 connects to arm 162, which itself is pivotally connected at hinge 164 to respective flanges 166 on an upper portion of outer cup 46a. In an exemplary embodiment, outer cup 46a includes a plurality of window apertures 168 through the vertical wall to reduce a weight and material usage of the articulating receptacle 30d.

The articulating receptacle 30d is configured as shown in FIGS. 19-21 as it approaches the loop spreader arms 86 of tagging machine 34, which are moved apart transversely to stretch open the elastomer loop 82 of a labeling article 78. The receptacle 30d proceeds into the opened and expanded elastomer loop 82 so that leading assemblies of fingers 88 and brackets 152 catch on the expanded elastomer loop 82. Continued motion of the receptacle 30d along the conveyance direction 42 pulls the labeling article 78 from the strip 84 of such articles, thereby rupturing an individual labeling article 78 from the strip 84. FIG. 23A shows expanded loop 82 retained on fingers 88 of articulating receptacle 30d.

FIGS. 23A-23C illustrate sequential steps in the travel of receptacle 30d along conveyor 36. As shown in FIG. 23A, a user has inserted a product 74 into the inner cup 46b while the receptacle 30d is in the work zone 44. The labeling article 78 is held on the assemblies of fingers 88 and brackets 152 by its expanded elastomer loop 82. As shown in FIG. 23B, as receptacle 30d is conveyed in direction 42 toward an end of the work zone 44, its rollers 98 ascend on upwardly inclined surfaces 104 of ramps 87. The inner cup 46b, which is fixed by base 64 to the conveyor chain 38, does not move upwardly. Thus, as the articulating receptacle 30d progresses up the ramp surface 104, the outer cup 46a moves upward in a sliding vertical motion relative to the inner cup 46b.

As the distance between roller shaft 100 and base 64 increases, the biasing mechanisms 102 stretch to accommodate the longer distance. As this happens, as shown in FIG. 23C, the brackets 152 and connected arms 162 pivot outward at hinges 154, 160, 164. Because the elastomer loop 82 is biased toward its unstretched configuration, raising side members 156 of brackets 152 to a more horizontal orientation allows the elastomer loop 82 to contract and slip off the sideways brackets 152 and onto the product 74 (not shown in this view) held within the articulating receptacle 30d. Further progression of the receptacle 30d in conveyance direction 42 causes the rollers 98 to track the downwardly inclined ramp surface 106, leaving the labeling article 78 attached to the product 74. The default bias of the mechanism 102 is toward a compressed state, thereby pulling the outer cup 46a down again relative to the inner cup 46b. This resets the articulating receptacle 30d to the configuration shown in FIGS. 19-21, wherein the fingers 88 and brackets 152 are essentially vertically aligned with each other at an upper portion of the cup 46.

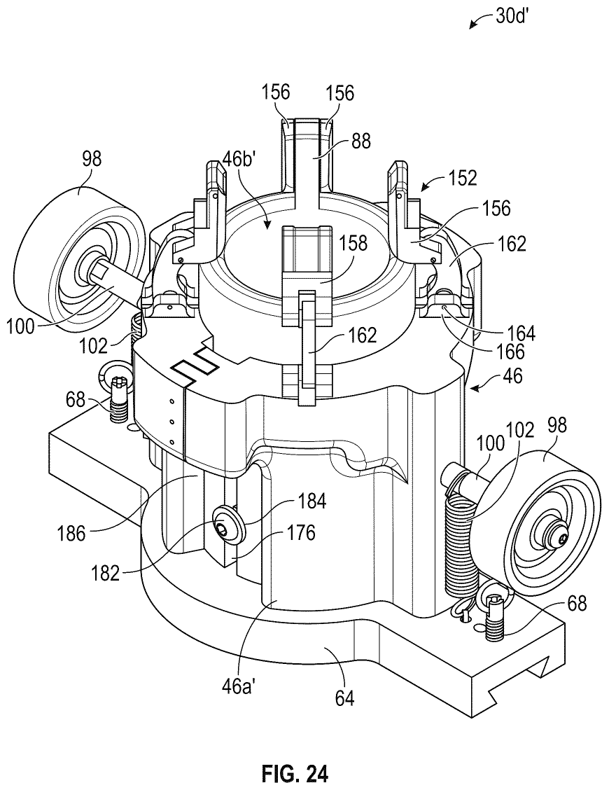

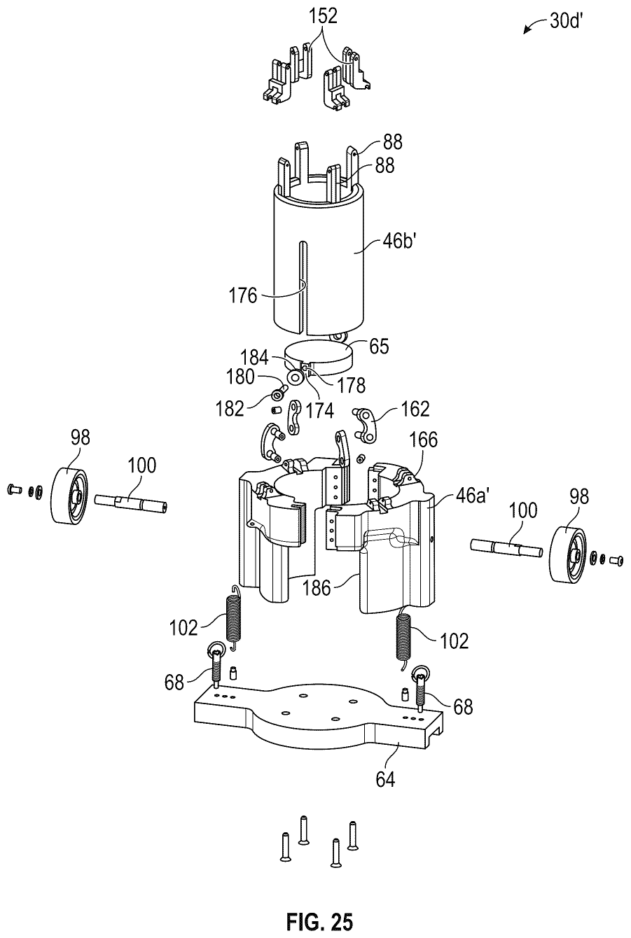

FIG. 24 is a perspective view of a variation of the fourth exemplary receptacle, designated as receptacle 30d′. FIG. 25 is an exploded perspective view of the receptacle of FIG. 24. This receptacle variation 30d′ is quite similar to receptacle 30d; primary differences are that it has an adjustable height floor 65 with changes in the structure of outer cup 46a′ and inner cup 46b′ to facilitate variability in a vertical position of the adjustable height floor 65. Receptacle 30d′ has fewer brackets 152 than receptacle 30d, but any number of brackets 152 and corresponding fingers 88 can be used.

In an exemplary method of assembly of receptacle 30d′, adjustable height floor 65 is inserted into an interior of the inner cup 46b′ from below, so that protrusions 174 are vertically slidable in slots 176 of inner cup 46b′. In an exemplary embodiment, each protrusion 174 has a threaded aperture 178 configured to receive a correspondingly externally threaded shaft 180 of knob 182. When assembled, knobs 182 can be tightened to compress holding surface 184 against an exterior of the inner cup 46b′ around the periphery of each slot 176, to thereby retain a desired height or elevation of adjustable floor 65 within the inner cup 46b′. In an exemplary embodiment, the outer cup 46a′ is provided in two parts, which when assembled maintain an opening 186 in which the knobs 182 on each side of the receptacle 30d′ can move up and down along slots 176. In the illustrated embodiment, holding surface 184 is a back surface of a washer.

In some implementations of receptacle 30, a product 74 configured for placement into cup 46 is elongated with a relatively small cross-sectional dimension. If such a product 74 is placed into a cup 46, it may lean or have another orientation that is less vertical than desired for optimal placement of a labeling article 78 in the use of system 32. Accordingly, in some implementations, an insert 170 can be placed inside the cup 46 (or its inner cup 46b) to provide a smaller and/or specifically shaped cavity 172 for receiving product 74.

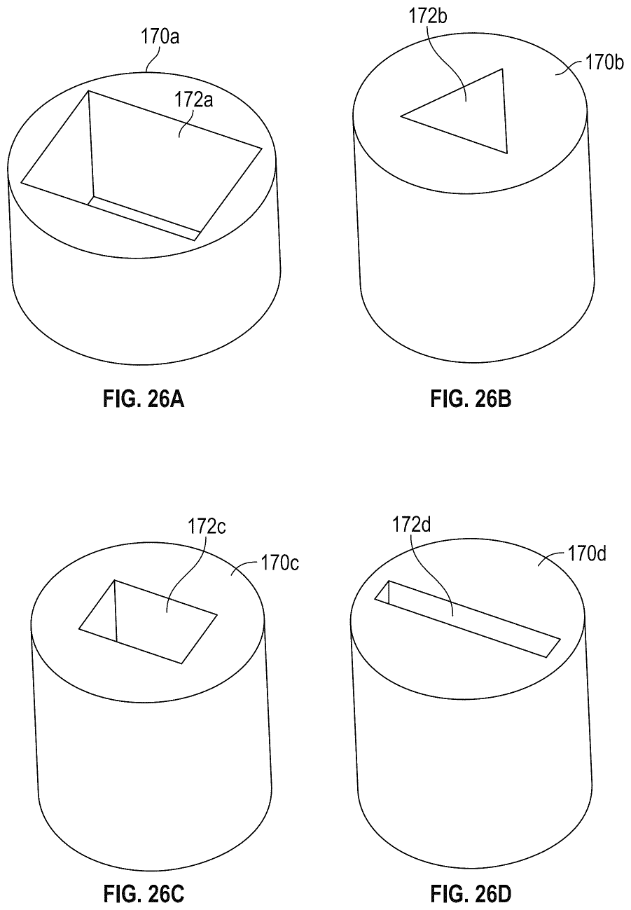

FIG. 26A shows an exemplary insert 170a configured to hold a product such as a coffee bag, which may have a substantially rectangular shaped bottom. Cavity 172a is shaped as a rectangular prism, and insert 170a is placed into a receptacle 30 so that cavity 172a is oriented as desired relative to the conveyance direction 42. FIG. 26B shows an exemplary insert 170b with a cavity 172b having a narrow triangular prism shape, configured for holding a product 74 such as a Toblerone brand candy bar, for example. FIG. 26C is a perspective view of an insert 170c with a cavity 172c having a rectangular prism shape, configured to hold a product shaped as a common type of candy bar, such as those with brand names Snickers, Milky Way, or Three Musketeers, for example. FIG. 26D is a perspective view of an exemplary insert 170d with a cavity 172d having a flat rectangular prism shape, configured to hold a product such as a flatter, wider chocolate bar such as a Hershey brand bar, for example.

In an exemplary embodiment, insert 170 has a substantially cylindrical outer contour that fits snugly into cup 46. The height of the insert 170 may be substantially similar to a height of a cup 46 or inner cup 46b (or an effective height above adjustable floor 65), or the height may be shorter. Generally, a height of an insert 170 will not be significantly greater than a height of cup 46 or inner cup 46b, to prevent interference with placing a labeling article 78 on a product 74 held within cavity 172. An insert 170 can be molded or otherwise formed from a lightweight yet durable and resilient material such as a polymer foam, for example. While several cavity configurations are illustrated, it is to be understood that cavity shape, size and depth can be used, depending on the product 74 to be inserted into the various receptacles 30. For example, to accommodate a cylindrical bottle product 74, an insert could have a cylindrical cavity 172. Moreover, each receptacle 30 can be sized and shaped according to the particular needs of any type of merchandise product. For illustration only, a suitable size for a cup 46 is one having an internal diameter of about 3 inches and a tag placement height of approximately 5 inches from the base 64.

The speed of the conveyor 36 in chain direction 42 can be varied to accommodate the needs of a particular product and operator set up. For example, a tagging machine 34 operated by a single individual could be moved at a rate in which labeling articles 78 are placed on only two or three products 74 per minute. In contrast, a system 32 operated by six or more people with a longer work zone 44 could tag perhaps up to 180 products 74 per minute. In an exemplary operation in which the tagging rate is 60 products per minute, the conveyor motor speed can be run at a rate of about 127 rotations per minute (RPM) to about 165 RPM. With a total chain length of conveyor chain 38 of about 148 inches, receptacles 30 can be placed about 12 or 13 inches apart to result in 12 cups spaced as evenly as possible over the chain length. With a work zone 44 having a length of about 27 inches and two operators, if the target tagging rate is 60 products per minute, each of the two operators will have two seconds to fill that operator's respective receptacles 30. With two operators, they would likely alternate in the filling of receptacles 30 that pass in direction 42 in work zone 44, in one implementation.

Non-limiting examples of an apparatus and method are described. In an exemplary embodiment, an apparatus 30 is configured to be mounted on a conveyor 36 that passes by a tagging machine 34, wherein the tagging machine 34 is configured to apply a labeling article 78. In an exemplary embodiment, the apparatus 30 comprises a first cup 46b, 46b′ attached to the conveyor 36, a second cup 46a, 46a′ slidably attached to the first cup 46b, 46b′ and a biasing mechanism 102 that biases the second cup 46a, 46a′ toward the conveyor 36. In an exemplary embodiment, a plurality of fingers 88 are disposed at an upper portion of the first cup 46b, 46b′ wherein a gap 96 of a plurality of gaps 96 is disposed between adjacent fingers 88 of the plurality of fingers 88. In exemplary embodiments as shown in FIGS. 4-13B, the second cup 46a, 46a′ comprises a plurality of teeth 94 aligned within each of the plurality of gaps 96. In some embodiments, the first cup is an inner cup and the second cup is an outer cup, though this relationship may be reversed.

In an exemplary embodiment as shown in FIGS. 19-25, a plurality of arms 162 are pivotally mounted to the second cup 46a, 46a′, such as at hinges 164. In an exemplary embodiment, each of a plurality of brackets 152 is pivotally mounted to one of the plurality of arms 162, such as at hinge 160, and pivotally mounted to one of the plurality of fingers, such as at hinge 154. In an exemplary embodiment, each of the plurality of brackets 152 has first and second side members 156 disposed on opposite sides of one of the plurality of fingers 88.

In an exemplary embodiment as shown in FIGS. 14-18F, first and second pegs 108 are pivotally mounted to an upper portion of the first cup 46b by respective first and second linkages 130. In an exemplary embodiment, a roller bar 116 is pivotally attached to each of the first and second linkages 130a, 130b by first and second arms 126. In an exemplary embodiment, a spring shaft 118 connects the first cup 46b and the roller bar 116. In an exemplary embodiment, the second cup 46a comprises a stand 110 comprising first and second legs 111 connected by a bridge 112, wherein the bridge 112 is configured to at least partially surround one of the first and second pegs 108 in a configuration of the apparatus in which the second cup 46a is raised relative to the first cup 46b, as shown in FIG. 18E, for example.

An exemplary method of applying a labeling article 78 to a product 74 comprises attaching a receptacle 30 to a conveyor 36 that passes by a tagging machine 34, wherein the tagging machine 34 is configured to apply the labeling article 78; and positioning the product 74 in the receptacle 30. An exemplary method comprises applying the labeling article 78 to a portion of the product 74a held in the receptacle 30a, as shown in FIG. 3, for example.

Another exemplary method comprises applying the labeling article 78 to a portion of the receptacle 30 before positioning the product 74 in the receptacle 30. In an exemplary method, the receptacle 30 comprises a first cup 46b, 46b′ and a second cup 46a, 46a′ the method comprising sliding the second cup 46a, 46a′ upward relative to the first cup 46b, 46b′ to urge the labeling article 78 off the portion of the receptacle 30 and onto the product 74. In an exemplary method, a biasing mechanism 102 is used to pull the second cup 46a, 46a′ downward relative to the first cup 46b, 46b′ after the labeling article 78 is removed from the portion of the receptacle 30.

In an exemplary method as illustrated in FIGS. 18A-18C, the portion of the receptacle 30c is a plurality of pegs 108 attached to the first cup 46b, the method comprising moving the plurality of pegs 108 toward each other before applying the labeling article 78 onto the plurality of pegs 108; and moving the plurality of pegs 108 away from each other before positioning the product 74 in the receptacle 30.

As illustrated in FIGS. 23A-25, the receptacle comprises a first cup 46b, 46b′ comprising a plurality of fingers 88; a second cup 46a, 46a′ comprising a plurality of pivotally mounted arms 162; and a plurality of brackets 152, wherein each of the plurality of brackets 152 is pivotally mounted to one of the plurality of arms 162 and pivotally mounted to one of the plurality of fingers 88. In an exemplary method, the portion of the receptacle on which the labeling article 78 is applied is a plurality of assemblies of brackets 152 and respective fingers 88. As shown in FIG. 23C, an exemplary method comprises sliding the second cup 46a, 46a′ upward relative to the first cup 46b, 46b′ so that for each of the assemblies, a lower portion of the bracket 152 pivots away from its respective finger 88.

In an exemplary embodiment, an apparatus 30 is configured to be mounted on a conveyor 36 that passes by a tagging machine 34, wherein the tagging machine 34 is configured to apply a labeling article 78. In an exemplary method, the apparatus comprises a bar 60 configured to be mounted on the conveyor 36; and a receptacle 30 comprising a base 64, the receptacle 30 configured to receive a product 74 to which the labeling article 78 is to be applied. In an exemplary embodiment, the bar 60 and base 64 have a sliding interface 63 for mutual connection and disconnection. In an exemplary embodiment as shown in FIGS. 1-3, the receptacle 30a comprises a cup 46; and a product support arm 48 attachable to the cup 46, wherein the product support arm 48 is configured for contact with a portion of the product 74 to which the labeling article 78 is to be applied. In an exemplary embodiment, the receptacle 30b, 30b′, 30c, 30d, 30d′ comprises a first cup 46b, 46b′ fixed to the base 64; a second cup 46a, 46a′ slidably attached to the inner cup 46b, 46b′; and a biasing mechanism 102 that biases the second cup 46a, 46a′ toward the base 64.

Although the subject of this disclosure has been described with reference to several embodiments, workers skilled in the art will recognize that changes may be made in form and detail without departing from the scope of the disclosure. In addition, any feature disclosed with respect to one embodiment may be included in another embodiment, and vice-versa. All references mentioned in this disclosure are hereby incorporated by reference.

1. An apparatus configured to be mounted on a conveyor that passes by a tagging machine, wherein the tagging machine is configured to apply a labeling article, the apparatus comprising:
a first cup attached to the conveyor;
a second cup slidably attached to the first cup; and
a biasing mechanism that biases the second cup toward the conveyor.

2. The apparatus of claim 1 comprising a plurality of fingers disposed at an upper portion of the first cup, wherein a gap of a plurality of gaps is disposed between adjacent fingers of the plurality of fingers.

3. The apparatus of claim 2 comprising:
a plurality of arms pivotally mounted to the second cup; and
a plurality of brackets, wherein each of the plurality of brackets is:
pivotally mounted to one of the plurality of arms; and
pivotally mounted to one of the plurality of fingers.

4. The apparatus of claim 3, wherein each of the plurality of brackets has first and second side members disposed on opposite sides of one of the plurality of fingers.

5. The apparatus of claim 2, wherein the second cup comprises a plurality of teeth aligned within each of the plurality of gaps.

6. The apparatus of claim 1 comprising first and second pegs pivotally mounted to an upper portion of the first cup by respective first and second linkages.

7. The apparatus of claim 6 comprising a roller bar pivotally attached to each of the first and second linkages by first and second arms.

8. The apparatus of claim 7 comprising a spring shaft connecting the first cup and the roller bar.

9. The apparatus of claim 6, wherein the second cup comprises a stand comprising first and second legs connected by a bridge, wherein the bridge is configured to at least partially surround one of the first and second pegs in a configuration of the apparatus in which the second cup is raised relative to the first cup.

10. A method of applying a labeling article to a product, the method comprising:
attaching a receptacle to a conveyor that passes by a tagging machine, wherein the tagging machine is configured to apply the labeling article; and
positioning the product in the receptacle.

11. The method of claim 10 comprising applying the labeling article to a portion of the product held in the receptacle.

12. The method of claim 10 comprising applying the labeling article to a portion of the receptacle before positioning the product in the receptacle.

13. The method of claim 12, wherein the receptacle comprises a first cup and a second cup, the method comprising sliding the second cup upward relative to the first cup to urge the labeling article off the portion of the receptacle and onto the product.

14. The method of claim 13 comprising using a biasing mechanism to pull the second cup downward relative to the first cup after the labeling article is removed from the portion of the receptacle.

15. The method of claim 13, wherein the portion of the receptacle is a plurality of pegs attached to the first cup, the method comprising:
moving the plurality of pegs toward each other before applying the labeling article onto the plurality of pegs; and
moving the plurality of pegs away from each other before positioning the product in the receptacle.

16. The method of claim 12,
wherein the receptacle comprises:
a first cup comprising a plurality of fingers;
a second cup comprising a plurality of pivotally mounted arms;
a plurality of brackets, wherein each of the plurality of brackets is:
pivotally mounted to one of the plurality of pivotally mounted arms; and
pivotally mounted to one of the plurality of fingers; and
wherein the portion of the receptacle is a plurality of assemblies of brackets and respective fingers.

17. The method of claim 16 comprising sliding the second cup upward relative to the first cup so that for each of the assemblies, a lower portion of the bracket pivots away from its respective finger.

18. An apparatus configured to be mounted on a conveyor that passes by a tagging machine, wherein the tagging machine is configured to apply a labeling article, the apparatus comprising:
a bar configured to be mounted on the conveyor; and
a receptacle comprising a base, the receptacle configured to receive a product to which the labeling article is to be applied;
wherein the bar and base have a sliding interface for mutual connection and disconnection.

19. The apparatus of claim 18, wherein the receptacle comprises:
a cup; and
a product support arm attachable to the cup, wherein the product support arm is configured for contact with a portion of the product to which the labeling article is to be applied.

20. The apparatus of claim 18, wherein the receptacle comprises:
a first cup fixed to the base;
a second cup slidably attached to the first cup; and
a biasing mechanism that biases the second cup toward the base.
